(19) United States
(12) Patent Application Publication
(10) Pub. No.: US 2023/0001251 A1
(43) Pub. Date: Jan. 5, 2023

(54) REMEDIATION OF PER- AND POLYFLUOROALKYL CONTAMINATED MATERIALS

(71) Applicant: The Johns Hopkins University, Baltimore, MD (US)

(72) Inventors: Zhiyong Xia, Rockville, MD (US); James K. Johnson, Silver Spring, MD (US); Jesse S. Ko, Bethesda, MD (US); Nam Q. Le, Fulton, MD (US); Danielle R. Schlesinger, Washington, DC (US); Dajie Zhang, Baltimore, MD (US); Plamen A. Demirev, Ellicott City, MD (US)

(21) Appl. No.: 17/840,666

(22) Filed: Jun. 15, 2022

Related U.S. Application Data
(60) Provisional application No. 63/211,639, filed on Jun. 17, 2021.
(60) Provisional application No. 63/275,042, filed on Nov. 3, 2021.
(60) Provisional application No. 63/299,039, filed on Jan. 13, 2022.

(51) Int. Cl. A62D 3/33; C07F 7/18; A62D 3/115; A62D 3/37

(52) U.S. Cl. CPC A62D 3/33; C07F 7/1804; A62D 3/115; A62D 3/37; A62D 2101/22

(57) ABSTRACT

A contaminant-sequestering coating includes a network of hydrolyzed silane compounds. The hydrolyzed silane compounds include a hydrophilic polar head region, a hydrophobic linker, and an anchor region including a silicon atom. The network of hydrolyzed silane compounds is devoid or substantially devoid of fluorine atoms. Methods of destroying one or more perfluoroalkyl and/or polyfluoroalkyl (PFAS) compounds present in a contaminant-containing liquid are also provided.

### CROSS-REFERENCE TO RELATED APPLICATIONS

This application claims priority to and the benefit of prior-filed, co-pending U.S. Provisional Application Nos. 63/211,639 filed on Jun. 17, 2021, 63/275,042 filed on Nov. 3, 2021, and 63/299,039 filed on Jan. 13, 2022, the entire content of each of which is herein incorporated by reference.

### TECHNICAL FIELD

Example embodiments relate generally to methods of treating and/or removing contaminants from contaminant-containing materials, such as liquids or fouled substrates.

### BACKGROUND

Clean water is a vital resource for life. This need has been realized since ancient times where civilizations would emerge and settle near sources of clean water. With the growth of industrial, materials, and agrochemical production, the contamination of aquatic sources is becoming more prevalent worldwide. Many contaminants (sometimes irregularly referred to as “contaminates”) have been reported in water, including pesticides, heavy metal ions, biological species, pharmaceutical residues, and per- and polyfluoroalkyl substances (PFAS). In particular, PFAS (formerly known as perfluorochemicals) have emerged as an increasingly common contaminant in drinking water that are very difficult to remove and persist in the environment due to their unique structures.

PFAS are synthetic compounds with multiple high energy C—F bonds that are used in industrial processes for the preparation of fire-resistant foams, protective coatings, and poly(tetrafluoroethylene) products. In particular, perfluorooctane sulfonic acid (PFOS) and perfluorooctanoic acid (PFOA) are two eight-carbon PFAS that are employed for a wide range of applications, including aqueous film-forming foams for firefighting, nonstick cookware, and water-resistant coatings for carpets, leather, and furniture; yet, these substances are widely present in water supplies. Due to the long human body accumulation times for PFOS (5.4 years) and PFOA (3.8 years), both chemicals have been linked to obesity, cancer, hormone disruption, and high cholesterol levels.

PFOS and PFOA may be introduced into the environment from the waste streams of industrial, military, or urban regions. The current state-of-the-art techniques for PFAS removal are adsorption on granular and powdered activated carbon, ion exchange resins, membrane filtration, and reverse osmosis. Of these approaches, adsorption on highly porous-activated carbon is the most commonly used method today; however, this approach is both nonselective for PFAS, with known limitations in removing shorter chain PFAS, and expensive to implement, which limits its application for large-scale filtration. An additional drawback of these technologies is that they typically concentrate PFAS onto filtration media resulting in ancillary waste streams. The latter, once released into the environment, will cause secondary PFAS contamination. As such, these commercial technologies never permanently eliminate these “forever chemicals” from the ecosystem. The main reason that PFAS are called “forever chemicals” is that the carbon-fluorine (C—F) bond energy is very high (536 kJ/mol, one of the strongest organic bonds) and thus is extremely hard to break via conventional bond breaking technologies. As a result, when PFAS compounds enter the environment, they build up and accumulate, rather than degrade.

Therefore, there remains a long-felt, substantial need for a technology that can sequester PFAS compounds, such as PFOS and PFOA to name a few, present in a liquid (e.g., water) source, and/or destroy PFAS compounds (whether present in a contaminated liquid or bound to a substrate), and sequester fluoride ions that may be generated via the destruction of the PFAS compounds.

### BRIEF SUMMARY

One or more non-limiting, example embodiments described herein solve one or more of the aforementioned problems.

In one example embodiment, a contaminant-sequestering coating includes a network of hydrolyzed silane compounds. The hydrolyzed silane compounds include a hydrophilic polar head region, a hydrophobic linker, and an anchor region including a silicon atom. The network of hydrolyzed silane compounds is devoid or substantially devoid of fluorine atoms.

In another example embodiment, a method of removing contaminants from a contaminant-containing liquid includes contacting the contaminant-containing liquid with a contaminant-sequestering coating. The contaminant-sequestering coating includes a network of hydrolyzed silane compounds, which include a hydrophilic polar head region, a hydrophobic linker, and an anchor region including a silicon atom. The network of hydrolyzed silane compounds is devoid or substantially devoid of fluorine atoms.

In yet another example embodiment, a method of destroying one or more perfluoroalkyl and/or polyfluoroalkyl (PFAS) compounds present in a contaminant-containing liquid includes breaking carbon-fluorine bonds present in at least a majority of the one or more PFAS compounds present in the contaminant-containing liquid. The destroying of the one or more PFAS compounds produces one or more hydrocarbon species or one or more organic acids and hydrogen fluoride, as well as excessive fluoride ions.

In still another example embodiment, a PFAS remediation method includes at least two of (i) sequestering one or more PFAS compounds from a contaminant-containing liquid including the one or more PFAS compounds, where the sequestering includes contacting the contaminant-containing liquid with a contaminant-sequestering material; (ii) destroying at least a majority of the one or more PFAS compounds by breaking carbon-fluorine bonds present in the majority of the one or more PFAS compounds, producing (a) one or more hydrocarbon species, one or more organic acids, and/or hydrogen fluoride, and (b) excessive fluoride ions; and (iii) sequestering the excessive fluoride ions in the liquid.

### BRIEF DESCRIPTION OF THE DRAWINGS

The above and other aspects, features, and advantages will become more readily apparent from the detailed description, accompanied by the drawings, within which like numbers refer to like elements, and in which:

FIG. 1 illustrates an example non-fluorinated silane including an anchor region, a linear carbon backbone, and a polar head region in accordance with certain embodiments;

FIG. 2 illustrates a flow diagram for remediation methods in accordance with certain embodiments;

FIG. 3 illustrates another flow diagram for remediation methods in accordance with certain embodiments;

FIG. 4 generally illustrates the anticipated lower energy LUMO of FLPs leading to increased reactivity, which may facilitate the use of FLP chemistry in the destruction of per- and polyfluoroalkyl substances (PFAS) compounds;

FIG. 5 illustrates a general method of destroying one or more PFAS compounds based on magnetite-catalyzed UV-Fenton chemistry in accordance with certain embodiments;

FIG. 6 illustrates >95% PFOA removal at neutral pH (pH 7), at 5 molarity (M) concentrations of peroxide, while PFOS was more easily removed than PFOA and achieved >95% removal even at neutral pH with lower peroxide concentration in accordance with certain embodiments; and

FIG. 7 illustrates that at a relatively high peroxide concentration, magnetite-catalyzed Fenton chemistry can achieve >95% removal of PFOA and PFOS even with only 100 ppm of magnetite nanoparticles in accordance with certain embodiments.

### DETAILED DESCRIPTION

Some non-limiting, example embodiments will be described more fully hereinafter with reference to the accompanying drawings, in which some, but not all embodiments are shown. Indeed, the invention shown, described, and/or claimed herein may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise.

Example embodiments relate generally to methods of treating and/or removing contaminants [e.g., per- and polyfluoroalkyl substances (PFAS) compounds] from contaminant-containing materials, such as liquids or fouled substrates (e.g., substrates having PFAS compounds sequestered thereon). In one aspect, certain embodiments provide a non-fluorinated contaminant-sequestering material (e.g., a dry or solid coating bonded to a substrate). For example, the contaminant-sequestering coating (e.g., in a dry state) may include a network of hydrolyzed (e.g., condensed) silane compounds, in which the hydrolyzed silane compounds include (a) a hydrophilic polar head region, (b) hydrophobic linker (e.g., hydrocarbon linker), and (c) an anchor region including a silicon atom. In accordance with certain example embodiments, the network of hydrolyzed silane compounds may be devoid or substantially devoid of fluorine atoms. In accordance with certain embodiments, the term “substantially devoid of fluorine atoms” may include at most 10 atomic percent of fluorine atoms (0.1 to 10 atomic percent) in the network of hydrolyzed silane compounds, such as at least about any of the following: 0.1, 0.5, 1, 2, 3, 4, and 5 atomic percent of fluorine atoms in the network of hydrolyzed silane compounds, and/or at most about any of the following: 10, 9, 8, 7, 6, and 5 atomic percent of fluorine atoms in the network of hydrolyzed silane compounds. The contaminant-sequestering coating may be deposited and/or bonded to a variety of substrates, such as inorganic substrates typically used in, for example, filtration media and ion-exchange resins. In accordance with certain embodiments, the network of hydrolyzed silane compounds may beneficially sequester a large array of PFAS [e.g., perfluorooctane sulfonic acid (PFOS) and perfluorooctanoic acid (PFOA)]. Non-limiting examples of PFAS include perfluorohexanoic acid (PFHxA), perfluorononanoic acid (PFNA), perfluorohexanesulfonic acid (PFHxS), perfluoroheptanoic acid (PFHpA), perfluorobutanesulfonic acid (PFBS), and GenX (e.g., a chemical process that uses 2,3,3,3-tetrafluoro-2-(heptafluoropropoxy)propanoic acid (FRD-903) and produces 2,3,3,3-tetrafluoro-2-(heptafluoropropoxy)propanoate (FRD-902) and heptafluoropropyl 1,2,2,2-tetrafluoroethyl ether (El), in which the chemicals are used in products such as food packaging, paints, cleaning products, non-stick coatings, outdoor fabrics, and firefighting foam).

In accordance with certain embodiments, the contaminant-sequestering coating may sequester or remove from about 50% to about 100% by weight of one or more PFAS, such as at least about any of the following: 50, 60, 70, 75, 80, and 85% by weight of one or more PFAS and/or one or more, and/or at most about any of the following: 100, 99.5, 99, 98, 97, 96, 95, 92, 90, 88, 86, and 85% by weight of one or more PFAS compounds. In accordance with certain embodiments, for example, the contaminant-sequestering coating may reduce the amount of one or more PFAS compounds present in a water stream or source to at or below about 80 parts-per-trillion, such as at or below about 70 parts-per-trillion as recommended by the U.S. environmental agency (EPA). In this regard, certain embodiments provide methods and devices that utilize the non-fluorinated contaminant-sequestering coating that may function as an ecofriendly ligand.

Example embodiments also provide several methods of destroying one or more PFAS compounds present in a contaminant-containing liquid and/or present on fouled or spent substrate via a contaminant-sequestering coating bonded thereon. In this regard, the PFAS compound may be destroyed while present within a liquid phase or sequestered by a contaminant-sequestering coating that is anchored or bonded to a suitable substrate (e.g., filtration medium, resin, etc.). In accordance with certain embodiments, the destruction of PFAS compounds may be performed by utilizing a chemical reaction using Frustrated Lewis Pairs (FLP) to perform fluoride abstraction on PFAS compounds to remove them from solution or from a spent substrate (e.g., filter medium) to which the PFAS compounds are sequestered via a contaminant-sequestering coating. The FLPs, for example, may be combined with the PFAS compounds and a reducing agent (e.g., triethylsilane) to form a reaction mixture. The reaction mixture may be heated at a desired temperature for a desired time to obtain a desired level of destruction of the PFAS compounds. The post-reaction mixture may be analyzed for percent PFAS compound removal using 19F NMR or LCMS/MS. In accordance with certain embodiments, such PFAS compound destruction methods may combine adsorption and/or sequestering of the PFAS compounds onto a suitable substrate (e.g., a filtration medium) followed by chemical decontamination of the substrate using FLPs and described and disclosed herein.

In accordance with certain embodiments, the destruction of PFAS compounds may be performed by oxidation techniques involving the production of reactive oxygen species (ROS) for bond cleavage, such as by the use of Fenton reagents, in which iron (Fe) species are oxidized or reduced in the presence of hydrogen peroxide (H₂O₂) and exposed to ultraviolet (UV) radiation, producing reactive oxygen species, including hydroxyl and peroxyl radicals, which are capable of cleaving C—F bonds. In accordance with certain embodiments, the foregoing process may be greatly improved via the use of magnetite (Fe₃O₄) nanoparticles (an iron spinel mineral), which catalyzes the Fenton reaction for destruction of PFAS compounds. Magnetite is a naturally occurring mineral, and when used in a nanoparticle form, the efficiency of PFAS compound destruction may be particularly desirable for robust destruction of unwanted PFAS compounds. Such embodiments provide, for instance, provide a novel, eco-friendly procedure for the efficient destruction of PFAS compounds. In accordance with certain embodiments, magnetite nanoparticles may be mixed into PFAS-contaminated liquid (e.g., water) at neutral pH or nearly neutral pH (e.g., pH from 6-8), near that of drinking water, as a suspension of nanoparticles. Hydrogen peroxide may be added either prior to, during, or subsequent to the addition of the magnetite nanoparticles to form a reaction mixture, which may be placed, for example, into a UV-C oven for a desired time (e.g., one hour). Following exposure to UV radiation, the post-reaction mixture may be filtered to separate the magnetite nanoparticles, and the remaining liquid (e.g., water) may be tested for PFAS concentration. In accordance with certain embodiments, these method for the destruction of PFAS compounds does not require addition of other ions, such as sulfate, and/or catalysts (e.g., devoid of sulfates) used in previous studies of Fenton reagents and is effective for multiple types of PFAS species. The result provides decontaminated, clean water, that can be further processed for drinking water sources or other valuable uses if so desired.

In accordance with certain embodiments, the destruction of PFAS compounds may be performed by an electrochemical technique, such as by direct or indirect oxidation of the PFAS compounds, driven by the formation of reactive oxygen species. In accordance with certain embodiments, the electrochemical technique or method may utilize a catalyst doped with niobium into ubiquitous titanium oxide, denoted as Nb-doped TiO₂. A variety of niobium dopant concentrations (e.g., atomic percentage) may be incorporated into a crystalline phase of the titanium oxide, heat treated (for example) at temperatures from 800 to 1100° C., which exhibit high oxidative stability and high generation of reactive oxygen free radical species. The capability of Nb-doped TiO₂ to destroy two common species of PFAS compounds in challenge water was tested for PFAS reduction, which was observed. In this regard, the Nb-doped TiO₂, in accordance with certain embodiments, provides a promising catalytic material with increased activity towards generating reactive oxygen species for electrochemically destroying PFAS compounds.

In accordance with certain embodiments, one or more PFAS compounds (whether present in a contaminated liquid or sequestered onto a contaminated substrate) may be destroyed using any combination of the PFAS destruction methods described and disclosed herein. For instance, certain embodiments provide methods of PFAS compound destruction by one or more modalities including FLP chemistry, eco-friendly Fenton chemistry, and novel catalysis enabled by electrochemical oxidation. In this regard, three parallel catalysis enabled technologies for breaking the carbon fluorine bonds in PFAS compounds are provided. However, any combination of these techniques may be employed for the destruction of PFAS compounds.

Since the destruction of the PFAS compounds includes the cleaving of the C—F bonds of the PFAS compounds, fluoride ions may be generated resulting in excessive fluoride ions present in the treated liquid (e.g., reaction mixture which may include a substrate or not). Such PFAS destruction by-products may be removed using environmentally benign minerals in accordance with certain embodiments. For instance, the excessive fluoride ions may be sequestered using ecofriendly hydroxyapatite minerals, which convert fluoride into environmentally benign fluorapatite minerals that can be, for example, landfilled safely for extended periods of time.

Still yet, certain embodiments provide a holistic PFAS remediation approach that may not only capture PFAS compounds (e.g., sequestered via a PFAS-sequestering coating) but also destroys them leading to full or near full PFAS elimination from the environment. The PFAS remediation methods may also include the sequestering of excessive fluoride ions as noted above. In accordance with certain embodiments, the PFAS remediation methods may include two or more of the following: (i) PFAS compound capture via a PFAS-sequestering coating applied or bonded to a suitable substrate; (ii) PFAS compound destruction, such as by one or more of (a) FLP chemistry, (b) ecofriendly Fenton chemistry, and/or (c) electrochemical oxidation, and (iii) sequestering of PFAS destruction by-products, such as by the formation of environmentally benign fluorapatite minerals.

(I) Non-Fluorinated Contaminant-Sequestering Materials, Methods, and Devices

In one aspect, certain embodiments provide a contaminant-sequestering material, such as a coating (e.g., in a dry and/or solid state) that includes a network of hydrolyzed (e.g., condensed) silane compounds, in which the hydrolyzed silane compounds include (a) a hydrophilic polar head region, (b) hydrophobic linker (e.g., hydrocarbon linker), and (c) an anchor region including a silicon atom. In accordance with certain example embodiments, the network of hydrolyzed silane compounds may be devoid or substantially devoid (as noted above) of fluorine atoms.

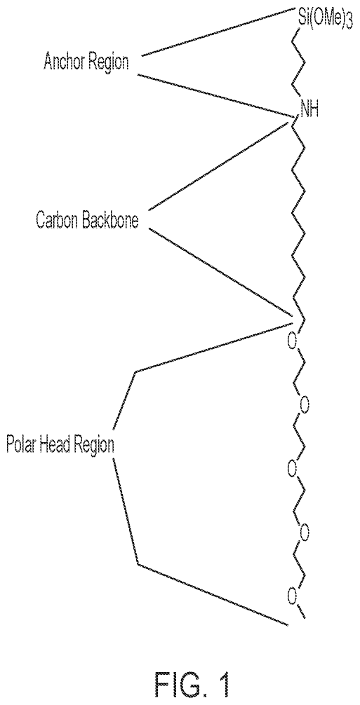

FIG. 1 illustrates an example non-fluorinated silane including an anchor region, a linear carbon backbone, and a polar head region in accordance with certain embodiments. As shown in FIG. 1, the anchor region may include a silicon atom having a plurality of reactive alkoxy groups bonded thereto as well as a heteroatom (e.g., nitrogen), and a methyl group (Me), e.g., CH₃. The hydrophilic polar head includes a plurality of EG units (e.g., polyethylene glycol functionality located at the opposite end of the anchor region). FIG. 1 also illustrates that the non-fluorinated silane may include a carbon backbone, such as a linear backbone.

In accordance with certain embodiments, the network of hydrolyzed silane compounds includes or is formed at least in part from one or more hydrolyzable thiol-functional silanes or silane compounds according to Formula (I):

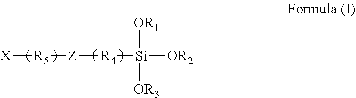

wherein,

OR₁, OR₂, and OR₃ are each hydrolyzable groups;

R₄ is a saturated C₁-C₂₀ radical (e.g., having from at least about any of the following: 1, 2, 3 4, 5, 6, 7, 8, 9, and 10 carbon atoms, and/or at most about any of the following: 20, 19, 18, 17 ,16, 15, 14, 13, 12, 11, and 10 carbon atoms) or an unsaturated C₁-C₂₀ radical (e.g., having from at least about any of the following: 1, 2, 3 4, 5, 6, 7, 8, 9, and 10 carbon atoms, and/or at most about any of the following: 20, 19, 18, 17 ,16, 15, 14, 13, 12, 11, and 10 carbon atoms);

R₅ is a saturated C₁-C₂₀ radical (e.g., having from at least about any of the following: 1, 2, 3 4, 5, 6, 7, 8, 9, and 10 carbon atoms, and/or at most about any of the following: 20, 19, 18, 17 ,16, 15, 14, 13, 12, 11, and 10 carbon atoms) or an unsaturated C₁-C₂₀ radical (e.g., having from at least about any of the following: 1, 2, 3 4, 5, 6, 7, 8, 9, and 10 carbon atoms, and/or at most about any of the following: 20, 19, 18, 17 ,16, 15, 14, 13, 12, 11, and 10 carbon atoms);

Z is a heteroatom selected from oxygen, nitrogen, sulfur, and phosphorus;

X is a polar group selected from —OH, —SH, or one or more ethylene glycol (EG) units.

In accordance with certain embodiments, OR₁, OR₂, and OR₃ of Formula (I) each include a respective alkyl group having from 1 to 5 carbon atoms, such as at least about any of the following: 1, 2, and 3 carbon atoms and/or at most about any of the following: 5, 4, and 3 carbon atoms. In this regard, the silicon atom may have one, two, or three reactive alkoxy groups that may hydrolyze to form a network of hydrolyzed silane compounds and to bond to an inorganic surface to form a contaminant-sequestering coating. In accordance with certain embodiments, the contaminant-sequestering coating may be formed from one or more (or all) hydrolyzable silane compounds of Formula (I), in which (i) OR₁, OR₂, and OR₃ each include a respective alkyl group having from 1 to 5 carbon atoms (as noted above), (ii) R₄ includes a saturated C₁-C₅ radical or an unsaturated C₁-C₅ radical, (iii) Z is a nitrogen atom, (iv) R₅ includes a saturated C₅-C₁₂ radical or an unsaturated C₅-C₁₂ radical; and (v) X includes from 1 to about 10 EG units (e.g., at least about any of the following: 1, 2, 3, 4, and 5 EG units, and/or at most about any of the following: 10, 9, 8, 7, 6, and 5 EG units).

In accordance with certain embodiments, the network of hydrolyzed silane compounds is devoid or substantially devoid of thiol groups. For instance the one or more hydrolyzable silane compounds according to Formula (I) (e.g., or the resulting hydrolyzed network) may be devoid or substantially devoid of fluorine atoms (as noted above) and thiol groups. In accordance with certain embodiments, the term “substantially devoid of thiol groups” may include at most 10 atomic percent of thiol groups (0.1 to 10 atomic percent) in the network of hydrolyzed silane compounds, such as at least about any of the following: 0.1, 0.5, 1, 2, 3, 4, and 5 atomic percent of thiol groups in the network of hydrolyzed silane compounds, and/or at most about any of the following: 10, 9, 8, 7, 6, and 5 atomic percent of thiol groups in the network of hydrolyzed silane compounds.

The contaminant-sequestering coating (e.g., non-fluorinated) sequesters (i) one or more PFAS compounds initially present in a liquid contaminated with an initial quantity of the PFAS compounds, in which an amount of the one or more PFAS compounds sequestered includes from about 50% to about 100% by weight of the initial quantity of the PFAS compounds, such as at least about any of the following: 50, 60, 70, 75, 80, and 85% by weight of the initial quantity of the PFAS compounds, and/or at most about any of the following: 100, 99.5, 99, 98, 97, 96, 95, 92, 90, 88, 86, and 85% by weight of the initial quantity of the PFAS compounds.

In accordance with certain embodiments, the contaminant-sequestering coating is disposed onto a surface of a substrate, for example, via the anchor region of the hydrolyzable silane compounds. For instance, the anchor region forms a bond with substrate (e.g., inorganic substrate). As noted above, the anchor region includes a silicon atom and at least one (e.g., one or more) hydrolyzable groups (e.g., alkoxy group) bonded to the silicon atom. In accordance with certain embodiments, the anchor region may also include one or more heteroatom selected from oxygen, nitrogen, sulfur, phosphorus, or combinations thereof. Accordingly, the polar head portion of the non-fluorinated silane compounds are located distal from the surface of the substrate and, thus, are located to enable interaction and sequestering of one or more PFAS compounds. The substrate (e.g., inorganic substrate), for example, may not be particularly limited and may include a filtration medium, nonwoven matt, nanofiltration membrane, microfiltration membrane, reverse osmosis membrane, an ion exchange resin, a structured packing material, or a random packing material (e.g., raschig rings). For example, the contaminant-sequestering coating may be disposed onto a variety of inorganic substrate, including a variety of filtration media, such as an aluminum oxide hydroxide (γ-AlOOH) mineral. In accordance with certain embodiments, the substrate includes a filtration medium that may include an aluminum oxide hydroxide (γ-AlOOH) mineral attached to micro-glass strands (e.g., an Ahlstrom DISRUPTOR® 4603 filter). In accordance with certain embodiments, the filtration medium may include an ultra-filter medium, a nano-filter medium, or a reverse osmosis membrane. The substrate may also include, for example, an ion-exchange resin. In accordance with certain embodiments, the substrate includes an aluminum oxide hydroxide (γ-AlOOH) mineral that may sequester or bind one or more biological species, such as Escherichia coli (E. coli) and/or virus bacteriophage MS2. In accordance with such embodiments, an initial quantity of one or more biological species may be reduced (e.g., sequester, removed, etc.) from at least about any of the following: 50, 60, 70, 80, and 85% by weight of an initial quantity of the biological species in a liquid and/or at most about any of the following: 100, 99, 98, 97, 95, 90, 88, and 80% by weight of an initial quantity of biological species in a liquid. In accordance with certain embodiments, a combination of one or more PFAS compounds, one or more heavy metals, and one or more biological species may simultaneously be reduced (e.g., sequester, removed, etc.) from at least about any of the following: 50, 60, 70, 80, and 85% by weight of an initial quantity thereof in a liquid and/or at most about any of the following: 100, 99, 98, 97, 95, 90, 88, and 80% by weight of an initial quantity thereof in a liquid.

In another aspect, certain embodiments provide a liquid composition including a flowable carrier medium and a plurality of hydrolyzable silane compounds that include (a) a hydrophilic polar head region, (b) hydrophobic linker (e.g., hydrocarbon linker), and (c) an anchor region including a silicon atom. In accordance with certain example embodiments, the network of hydrolyzed silane compounds may be devoid or substantially devoid of fluorine atoms and/or devoid or substantially devoid of thiol groups. In this regard, the liquid composition may be applied or coated onto a substrate of interest and hydrolyzed (e.g., condensed) to form a contaminant-sequestering coating that sequesters one or more PFAS compounds. In accordance with certain embodiments, the flowable carrier medium may include an organic solvent, an alcohol, or an aqueous-based solvent. In accordance with certain embodiments, the liquid composition may include one or more surfactants and/or thickeners to tailor the viscosity of the liquid composition depending on desired coating modalities (e.g., spraying, batch dipping, brushing, etc.) and/or the particular substrate to be coated with the liquid composition. The liquid composition, for example, may include a solution, suspension, or colloid including a plurality of hydrolyzable silane compounds according to Formula (I). In accordance with certain embodiments, the hydrolyzable silane compounds according to Formula (I) may include from about 0.01% to about 20% by weight of the liquid composition, such as at least about any of the following: 0.01, 0.05, 0.1, 0.5, 1, 3, 5, 8, 10, and 12% by weight of the liquid composition and/or at most about 20, 18, 15, 12, and 10% by weight of the liquid composition. The liquid composition, for example, may be shipped to a point of use or produced on-site (i.e., a point of use) and applied to a substrate (e.g., filter media, ion exchange resin, etc.) to provide a contaminant-sequestering coating thereon.

In another aspect, certain embodiments provide a method of functionalizing a surface of a substrate with contaminant-sequestering functionalities. In accordance with certain embodiments, the method of functionalizing a substrate (e.g., an inorganic substrate) surface with contaminant-sequestering functionalities includes covering an inorganic substrate with a liquid composition including a plurality of hydrolyzable silane compounds including include (a) a hydrophilic polar head region, (b) hydrophobic linker (e.g., hydrocarbon linker), and (c) an anchor region including a silicon atom. In accordance with certain embodiments, the plurality of hydrolyzable silane compounds are devoid or substantially devoid of fluorine atoms and/or devoid or substantially devoid of thiol groups. In accordance with certain embodiments, the liquid composition may be devoid or substantially devoid of fluorine atoms and/or devoid or substantially devoid of thiol groups. In accordance with certain embodiments, the method may further include hydrolyzing the plurality of hydrolyzable silane compounds to form a contaminant-sequestering coating on the inorganic substrate, in which the contaminant-sequestering coating includes a network of the hydrolyzed silane compounds, such as those described and disclosed herein. In accordance with certain embodiments, the inorganic substrate may include (as noted above) a filtration medium, nonwoven matt, nanofiltration membrane, microfiltration membrane, reverse osmosis membrane, an ion exchange resin, a structured packing material, or a random packing material (e.g., raschig rings).

In accordance with certain embodiments, the step of covering a substrate (e.g., an inorganic substrate) with a liquid composition including a plurality of hydrolyzable silane compounds according to Formula (I) may include submerging the substrate within the liquid composition, which may be housed within a vessel, or pumping the liquid composition over the surface of the substrate and/or through the thickness of the substrate (e.g., pumping the liquid composition through a filter media or through a bed of ion-exchange resin). Additionally or alternatively, the liquid composition may be sprayed or brushed onto the substrate. In accordance with certain embodiments, the step of covering the substrate with the liquid composition may include contacting the substrate with the liquid composition for at least about 0.5 minutes to about 120 minutes, such as at least about any of the following: 0.5, 1, 5, 10, 15, 25, 30, 40, 50, 60, 70, 80, and 90 minutes and/or at most about 120, 110, 100, 90, 80, and 70 minutes.

In accordance with certain embodiments, the method of functionalizing a substrate surface with contaminant-sequestering functionalities may further include adding a total amount of the hydrolyzable silane compounds as disclosed herein to the flowable carrier. In accordance with certain embodiments, the hydrolyzable silane compounds [e.g., according to Formula (I) may include from about 0.01% to about 20% by weight of the liquid composition, such as at least about any of the following: 0.01, 0.05, 0.1, 0.5, 1, 3, 5, 8, 10, and 12% by weight of the liquid composition and/or at most about 20, 18, 15, 12, and 10% by weight of the liquid composition. In accordance with certain embodiments, the step of adding the total amount of the hydrolyzable silane compounds to a flowable carrier includes selecting the total amount of hydrolyzable silane compounds to provide at least a monolayer coverage of the surface area with the network of the hydrolyzed silane compounds.

In accordance with certain embodiments, the method of functionalizing a substrate surface with contaminant-sequestering functionalities may further include cleaning the substrate (e.g., inorganic substrate) prior to covering the substrate (e.g., inorganic substrate) with the liquid composition. For example, the step of washing the base surface with alcohol, acetone, toluene and the like, the step of cleaning the substrate (e.g., inorganic substrate) may include oxygen plasma treating the substrate prior to contacting the substrate with the liquid composition having a plurality of hydrolyzable silane compounds such as those described and disclosed herein. Cleaning (e.g., pre-treating the surface of the substrate) the substrate may facilitate silanization of the substrate.

In another aspect, certain embodiments provide a method of removing contaminants from a contaminant-containing liquid, in which the method includes contacting the contaminant-containing liquid with a contaminant-sequestering coating (e.g., in a dry and/or solid state) that includes a network of hydrolyzed silane compounds. The hydrolyzed silane compounds may include (a) a hydrophilic polar head region, (b) hydrophobic linker (e.g., hydrocarbon linker), and (c) an anchor region including a silicon atom. In accordance with certain example embodiments, the network of hydrolyzed silane compounds may be devoid or substantially devoid of fluorine atoms and/or devoid or substantially devoid of thiol groups. In accordance with certain embodiments, the contaminant-containing liquid includes water that includes one or more PFAS compounds.

In accordance with certain example embodiments, the step of contacting the contaminant-containing liquid with a contaminant-sequestering coating includes flowing the contaminant-containing liquid across and/or through a substrate including the contaminant-sequestering coating bonded thereon. Additionally or alternatively, the step of contacting the contaminant-containing liquid with a contaminant-sequestering coating may include recirculating the contaminant-containing liquid across and/or through the substrate until a desired reduction and/or desired concentration of the one or more PFAS compounds is achieved.

In accordance with certain example embodiments, the step of contacting the contaminant-containing liquid with a contaminant-sequestering coating may include contacting the contaminant-containing liquid with a first contaminant-sequestering coating followed by contacting the contaminant-containing liquid with a second contaminant-sequestering coating. In accordance with certain embodiments, the first contaminant-sequestering coating and the second contaminant-sequestering coating are each devoid or substantially devoid of fluorine atoms and/or devoid or substantially devoid of thiol groups, and wherein the second contaminant-sequestering coating may be the same or different from the first contaminant-sequestering coating. In accordance with certain example embodiments, the first contaminant-sequestering coating may be supported on a first substrate in a first unit operation (e.g., vessel or compartment) and the second contaminant-sequestering coating may be supported on a second substrate in a second unit operation (e.g., vessel or compartment). The first contaminant-sequestering coating, in accordance with certain embodiments, may have a higher sequestering affinity for a first PFAS compound compared to the second contaminant-sequestering material, and the second contaminant-sequestering material may have a higher affinity for a second PFAS compound compared to the first contaminant-sequestering coating.

In accordance with certain example embodiments, the step of contacting the contaminant-containing liquid with a contaminant-sequestering coating may include contacting the contaminant-containing liquid with a first contaminant-sequestering coating followed by contacting the contaminant-containing liquid with a second contaminant-sequestering coating. In accordance with certain embodiments, the first contaminant-sequestering coating and the second contaminant-sequestering coating are each devoid or substantially devoid of fluorine atoms and/or devoid or substantially devoid of thiol groups, and wherein the second contaminant-sequestering coating may be the same or different from the first contaminant-sequestering coating. In accordance with certain example embodiments the first contaminant-sequestering material may be supported on a first substrate and the second contaminant-sequestering material may be supported on a second substrate, in which the first contaminant-sequestering coating and the second contaminant-sequestering coating are each devoid or substantially devoid of fluorine atoms and/or devoid or substantially devoid of thiol groups, and wherein the second contaminant-sequestering coating may be the same or different from the first contaminant-sequestering coating. In accordance with certain embodiments, the first contaminant-sequestering material and the second contaminant-sequestering material are housed in the same unit operation (e.g., vessel or compartment, such as a mixed bed ion exchange column). In accordance with certain embodiments, the first contaminant-sequestering coating may have a higher sequestering affinity for a first PFAS compound compared to the second contaminant-sequestering coating, and the second contaminant-sequestering coating may have a higher affinity for a second PFAS compound compared to the first contaminant-sequestering coating. The same unit operation, for example, may include a vessel including a first packing material and a second packing material or a filtration unit including a first filtration media including the first contaminant-sequestering coating and the second filtration media including the second contaminant-sequestering coating.

In another aspect, certain embodiments provide a device including a substrate, such as those described and disclosed herein, and a contaminant-sequestering coating, such as those described and disclosed herein, bonded to at least a portion of the substrate, such as those described and disclosed herein, in which the contaminant-sequestering coating includes a network of hydrolyzed silane compounds according to Formula (I).

(II) Destruction of PFAS Compounds

In another aspect, certain embodiments provide a method of destroying one or more PFAS compounds present in a contaminant-containing liquid. The method may include breaking carbon-fluorine bonds (e.g., a majority or all carbon-fluorine bonds) present in at least a majority of the one or more PFAS compounds present in the contaminant-containing liquid. In accordance with certain embodiments, the method may include breaking from 20 to 100% of the carbon-fluorine bonds of the one or more PFAS compounds, such as at least about any of the following: 20, 30, 40, 50, and 60% of the carbon-fluorine bonds of the one or more PFAS compounds, and/or at most about any of the following: 100, 98, 95, 90, 85, 80, 70, and 60% of the carbon-fluorine bonds of the one or more PFAS compounds. The step of destroying at least a majority of the one or more PFAS compounds may produce (a) one or more hydrocarbon species or one or more organic acids, hydrogen fluoride, and (b) excessive fluoride ions. In accordance with certain embodiments, the step of destroying at least a majority of the one more PFAS compounds may include (a) forming a reactant mixture including the one or more PFAS compounds from the contaminant-containing liquid, a FLP, and a reducing agent, and (b) performing a fluoride-cleaving reaction breaking carbon-fluorine bonds (e.g., at least a majority or all carbon-fluorine bonds) present in at least a majority of the one or more PFAS compounds by maintaining the reactant mixture at an elevated temperature for a reaction time sufficient to achieve a desired degree of fluoride abstraction on the one or more PFAS compounds.

In accordance with certain example embodiments, the elevated temperature may include temperatures ranging from 30 to 150° C., such as at least about any of the following: 30, 40, 50, 60, 70, and 75° C., and/or at most about any of the following: 150, 140, 130, 120, 110, 105, 100, 90, 80, and 75° C. Additionally or alternatively, the reaction time includes from about 6 hours to about 36 hours, such as at least about any of the following: 6, 8, 10, 12, 14, 15, 16, 18, 20, 22, 24, and 25 hours, and/or at most about any of the following: 36, 34, 32, 30, 28, 26 and 25 hours.

In accordance with certain example embodiments, the FLP includes a Lewis acid and a Lewis base that are hindered from bonding to form a Lewis acid-base adduct, in which the Lewis acid includes a carbenium ion, alkyl or aryl phosphine, or an alkyl silylium ion. In accordance with certain embodiments, the Lewis acid may include a silylium ion including one or more alkyl radicals bonded to a silicon atom of the silylium ion. The one or more alkyl radicals may each independently from each other have from 1 to 20 carbon atoms, such as at least about any of the following: 1, 2, 3 4, 5, 6, 7, 8, 9, and 10 carbon atoms, and/or at most about any of the following: 20, 19, 18, 17 ,16, 15, 14, 13, 12, 11, and 10 carbon atoms. For example, the Lewis acid may include a silylium ion generated from one or more trialkylsilanes, such as triethylsilane and triisopropyl silane. The silylium ion, for example, may be a silylium catalyzed hydrodefluorination generated using trityltetrakis[3,5-bis(trifluoromethyl)phenyl]borate or similar compound (e.g., structurally similar and/or functionally similar).

In accordance with certain example embodiments, the Lewis acid includes one or more alkyl radicals and/or one or more aromatic radicals bonded to a positively charged carbon atom. The alkyl radicals may independently from each other include from about 1 to about 20 carbon atoms, such as from at least about any of the following: 1, 2, 3 4, 5, 6, 7, 8, 9, and 10 carbon atoms, and/or at most about any of the following: 20, 19, 18, 17 ,16, 15, 14, 13, 12, 11, and 10 carbon atoms. Additionally or alternatively, the aromatic radicals, if utilized, may independently from each other include from 1 to 5 ring structures, such as at least about any of the following: 1, 2, and 3 ring structures, and/or at most about any of the following: 5, 4, and 3 ring structures. Additionally or alternatively, the one or more aromatic radicals independently from each other include from 5 to 30 carbon atoms, such as at least about any of the following: 5, 6, 8, 10, 12, 15, and 18 carbon atoms, and/or at most about any of the following: 30, 28, 26, 25, 24, 22, 20, and 18 carbon atoms.

In accordance with certain example embodiments, the Lewis base may include a boron-containing Lewis base. For example, the boron-containing Lewis base may include a tetraarylborane or weakly coordinating anion species. In accordance with certain example embodiments, the Lewis base may include one or more aromatic radicals bonded to a centrally located boron atom. The aromatic radicals, for example, may independently from each other include from 1 to 5 ring structures, such as at least about any of the following: 1, 2, and 3 ring structures, and/or at most about any of the following: 5, 4, and 3 ring structures. Additionally or alternatively, the one or more aromatic radicals independently from each other may include from 5 to 30 carbon atoms, such as at least about any of the following: 5, 6, 8, 10, 12, 15, and 18 carbon atoms, and/or at most about any of the following: 30, 28, 26, 25, 24, 22, 20, and 18 carbon atoms. The boron-containing Lewis base, in accordance with certain embodiments, may be trityltetrakis[3,5-bis(trifluoromethyl)phenyl]borate.

In accordance with certain example embodiments, the reducing agent includes a silane reducing agent. The silane reducing agent, by way of example only, may include a tri-substituted silane reducing agent, such as Triethylsilane, Trimethylsilane, Triisopropylsilane, Triphenylsilane, Tri-n-propylsilane, Tri-n-hexylsilane, Tris(trimethylsilyl)silane, Di-tert-butylmethylsilane, Diethylmethylsilane, Ethyldimethylsilane, or any combination thereof. Additionally or alternatively, the silane reducing agent may include a dialkylsilyl reducing agent, such as Dimethylsilane, Di-tert-butylsilane, Diethylsilane, Diphenylsilane, Phenylmethylsilane, or any combination thereof. Additionally or alternatively, the silane reducing agent may include a mono-substituted silane reducing agent, a di-substituted silane reducing agent, or tri-substituted silane reducing agent. In accordance with certain example embodiments, the silane reducing agent is a trialkyl silane.

In accordance with certain example embodiments, the FLP includes trialkylsilanes in combination with trityltetra(pentafluorophenyl)borate.

In accordance with certain example embodiments, the one or more PFAS compounds may be sequestered via a contaminant-sequestering material including a coating bonded to a substrate, such as those described and disclosed herein. The step of forming the reactant mixture, in accordance with certain embodiments, may include mixing the substrate having the one or more PFAS compounds sequestered thereon, the reducing agent, and the FLP. The order of addition of the reducing agent, the FLP, and the substrate having the one or more PFAS compounds may be interchanged in any order in accordance with certain embodiments. In this regard, the method may include performing the fluoride-cleaving reaction in the presence of the substrate (e.g., a spent substrate such as a filter medium).

In accordance with certain example embodiments, wherein the method includes destroying at least a majority of the one more PFAS compounds in the presence of the substrate includes destroying from 60% to 100% of the one or more PFAS compounds, such as at least about any of the following: 60, 65, 70, and 75% of the one or more PFAS compounds, and/or at most about any of the following: 100, 99, 98, 97, 96, 95, 90, 85, 80, and 75% of the one or more PFAS compounds. Additionally or alternatively, the method may include recovering the substrate after completion of the fluoride-cleaving reaction (e.g., destruction of the one or more PFAS compounds) to provide a regenerated substrate for additional PFAS sequestering.

In accordance with certain embodiments, the method includes destroying at least a majority of the one more PFAS compounds present in a contaminated liquid (e.g., water), such as such as at least about any of the following: 60, 65, 70, and 75% of the one or more PFAS compounds, and/or at most about any of the following: 100, 99, 98, 97, 96, 95, 90, 85, 80, and 75% of the one or more PFAS compounds.

In this regard, the destruction of one or more PFAS compounds utilizing FLPs, such as disclosed and described herein, may be performed directly on the contaminant-containing liquid or on a substrate having the one or more PFAS compounds sequestered thereon, for example, via a contaminant-sequestering coating bonded to the substrate.

In another aspect, certain embodiments provide a method of destroying one or more PFAS compounds present in a contaminant-containing liquid. The method may include breaking carbon-fluorine bonds (e.g., a majority or all carbon-fluorine bonds) present in at least a majority of the one or more PFAS compounds present in the contaminant-containing liquid. The step of destroying at least a majority of the one or more PFAS compounds may produce (a) one or more hydrocarbon species or one or more organic acids, hydrogen fluoride, and (b) excessive fluoride ions. In accordance with certain embodiments, the step of destroying at least a majority of the one more PFAS compounds may include (a) forming a reaction mixture including the one or more PFAS compounds, a plurality compounds magnetite nanoparticles, hydrogen peroxide, and optionally one or more sulfates, and (b) performing a fluoride-cleaving reaction breaking carbon-fluorine bonds present in at least a majority of the one or more PFAS compounds by exposing the reaction mixture to ultraviolet (UV) radiation.

In accordance with certain embodiments, the reaction mixture may be exposed to UV radiation from about 0.25 hours to about 24 hours, such as at least about any of the following: 0.25, 0.5, 0.75, 1, 1.25, and 1.5 hours, and/or at most about any of the following: 3, 2.5, 2, and 1.5 hours. Additionally or alternatively, the reaction mixture may be exposed to UV radiation having an average wavelength from about 100 nm to about 400 nm during the fluoride-cleaving reaction, such as at least about any of the following: 100, 150, 200, and 250 nm, and/or at most about any of the following: 400, 350, 300, and 250 nm. Additionally or alternatively, the reaction mixture may be maintained at a pH from about 5 to about 9 during the fluoride-cleaving reaction, such as at least about any of the following: 5, 5.5, 6, 6.2, 6.5, 6.8, and 7, and/or at most about any of the following: 9, 8.5, 8 7.8, 7.5, 7.2, and 7.

In accordance with certain embodiments, the plurality of magnetite nanoparticles may have an average diameter from about 1 nm to about 100 nm, such as at least about any of the following: 1, 5, 10, 15, 20, 25, 30, 35, 40, 45, and 50 nm, and/or at most about any of the following: 100, 90, 80, 70, 60, and 50 nm.

In accordance with certain embodiments, the one or more PFAS compounds are sequestered via a contaminant-sequestering material including a coating, such as those described and disclosed herein, bonded to a substrate. The step of forming the reactant mixture, in accordance with certain embodiments, may include mixing the substrate having the one or more PFAS substances sequestered thereon, the hydrogen peroxide, optionally one or more sulfates, and the plurality of magnetite nanoparticles.

The order of addition of the substrate having the one or more PFAS substances sequestered thereon, the hydrogen peroxide, the plurality of magnetite nanoparticles, and the optional sulfate ions may be interchanged in any order in accordance with certain embodiments. In this regard, the method may include performing the fluoride-cleaving reaction in the presence of the substrate (e.g., a spent substrate such as a filter medium).

In accordance with certain embodiments, the step of destroying at least a majority of the one more PFAS compounds in the presence of the substrate includes destroying from 60% to 100% of the one or more PFAS compounds, such as at least about any of the following: 60, 65, 70, and 75% of the one or more PFAS compounds, and/or at most about any of the following: 100, 99, 98, 97, 96, 95, 90, 85, 80, and 75% of the one or more PFAS compounds. Additionally or alternatively, the method may include recovering the substrate after completion of the fluoride-cleaving reaction to provide a regenerated substrate for additional PFAS sequestering.

Certain embodiments provide a method of destroying one or more PFAS compounds present in a contaminant-containing liquid. The method may include breaking carbon-fluorine bonds (e.g., a majority or all carbon-fluorine bonds) present in at least a majority of the one or more PFAS compounds present in the contaminant-containing liquid. The step of destroying at least a majority of the one or more PFAS compounds may produce (a) one or more hydrocarbon species or one or more organic acids, hydrogen fluoride, and (b) excessive fluoride ions. In accordance with certain embodiments, the step of destroying at least a majority of the one more PFAS compounds may include forming the reactant mixture by mixing the contaminant-containing liquid having the one or more PFAS substances, the hydrogen peroxide, optionally one or more sulfates, and the plurality of magnetite nanoparticles and (b) performing a fluoride-cleaving reaction breaking carbon-fluorine bonds present in at least a majority of the one or more PFAS compounds by exposing the reaction mixture to ultraviolet (UV) radiation.

In accordance with certain embodiments, the fluoride-cleaving reaction, whether the substrate is present or not, may be devoid of the addition or presence of sulfate ions, such as iron (II) sulfate. Additionally or alternatively, the hydrogen peroxide is provided in a stoichiometric excess.

In another aspect, certain embodiments provide a method of destroying one or more PFAS compounds present in a contaminant-containing liquid. The method may include breaking carbon-fluorine bonds (e.g., a majority or all carbon-fluorine bonds) present in at least a majority of the one or more PFAS compounds present in the contaminant-containing liquid. The step of destroying at least a majority of the one or more PFAS compounds may produce (a) one or more hydrocarbon species or one or more organic acids, hydrogen fluoride, and (b) excessive fluoride ions. In accordance with certain embodiments, the step of destroying at least a majority of the one more PFAS compounds may include an electrochemical oxidative process that directly or indirectly oxidizes the one or more PFAS compounds via catalysis-induced reactive free radicals at one or more electrodes, wherein the electrochemical oxidative process includes a niobium-doped titanium oxide (NB-doped TiO₂) catalyst. In accordance with certain embodiments, the titanium dioxide may include rutile titanium dioxide, anatase titanium dioxide, or a mixture of both.

In accordance with certain embodiments, the NB-doped TiO₂ includes from about 5 to about 20 atomic percent of niobium, such as at least about any of the following: 5, 6, 8, 10, 12, and 12.5 atomic percent of niobium, and/or at most about any of the following: 20, 18, 16, 15, 14, and 12.5 atomic percent of niobium.

The NB-doped TiO₂ catalyst, in accordance with certain embodiments, may be incorporated into an electrode composition, such as in the body of an electrode, and/or provided a part of a surface coating deposited onto an electrode, such as overlaying a body portion of an electrode. The NB-doped TiO₂ catalyst exhibits high oxidative stability and high generation of reactive oxygen free radical species suitable for destroying the one or more PFAS compounds by cleaving C—F bonds thereon.

(III) Sequestering of PFAS-Destruction By-Products

Since the destruction of the PFAS compounds, such as by the method described and disclosed herein, includes the cleaving of the C—F bonds of the PFAS compounds, fluoride ions may be generated resulting in excessive fluoride ions present in the treated liquid (e.g., reaction mixture which may include a substrate or not). Such PFAS destruction by-products, in accordance with certain embodiments, may be removed using environmentally benign minerals. For instance, the excessive fluoride ions generated by the cleaving of C—F bonds of the one or more PFAS compounds may be sequestered using ecofriendly hydroxyapatite minerals, which convert fluoride into environmentally benign fluorapatite minerals that can be, for example, landfilled safely for extended periods of time. In accordance with certain embodiments, sequestering the fluoride ions may include contacting the fluoride ions cleaved from the one or more PFAS compounds with one or more phosphate-based and/or calcium-based minerals and forming one or more fluorapatite minerals.

In accordance with certain embodiments, the fluoride ions may be contained within a post-fluoride-cleaving reaction mixture or other carrier liquid (e.g., water treated via a PFAS destruction method as described and disclosed herein), and wherein the post-fluoride-cleaving reaction mixture or other carrier liquid are (i) mixed with the one or more phosphate-based and/or calcium-based minerals, (ii) flowed through a bed of the one or more phosphate-based and//or calcium-based minerals, or both (i) and (ii). The one or more phosphate-based and/or calcium-based minerals may include hydroxyapatite minerals. Additionally or alternatively, the resulting fluorapatite minerals may be deposited in a landfill.

(IV) Full PFAS Remediation Methods

In yet another aspect, certain embodiments provide a PFAS remediation method, in which the remediation method may include at least two of the following: (1) sequestering one or more PFAS compounds from a contaminant-containing liquid including the one or more PFAS compounds, in which sequestering the one or more PFAS substances includes contacting the contaminant-containing liquid with a contaminant-sequestering material (e.g., coating such as those described and disclosed herein); (2) destroying at least a majority of the one or more PFAS compounds by breaking carbon-fluorine bonds (e.g., a majority or all carbon-fluorine bonds) present in at least a majority of the one or more PFAS compounds, wherein the step of destroying at least a majority of the one or more PFAS compounds by breaking carbon-fluorine bonds may include any method or combination of methods described and disclosed herein; and (3) sequestering the excessive fluoride ions (e.g., which may have been released from the PFAS compounds pursuant to a fluoride-cleaving reaction breaking carbon-fluorine bonds present in at least a majority of the one or more PFAS compounds) in the liquid (e.g., reaction mixture).

In this regard, certain embodiment provide a holistic PFAS remediation approach that may not only capture PFAS compounds (e.g., sequestered via a PFAS-sequestering coating) but also destroys them leading to full or near full PFAS elimination from the environment. The PFAS remediation methods may also include the sequestering of excessive fluoride ions as noted above. In accordance with certain embodiments, the PFAS remediation methods may include two or more of the following: (i) PFAS compound capture via a PFAS-sequestering coating applied or bonded to a suitable substrate; (ii) PFAS compound destruction, such as by one or more of (a) FLP chemistry, (b) ecofriendly Fenton chemistry, and/or (c) catalysis enabled destruction by electrochemical oxidation, and (iii) sequestering of PFAS destruction by-products, such as by the formation of environmentally benign fluorapatite minerals.

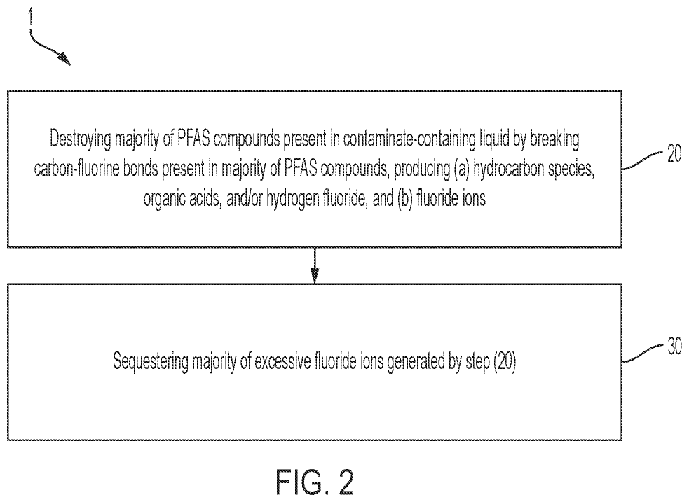

FIG. 2 illustrates a flow diagram for remediation methods 1 in accordance with certain embodiments. The remediation methods illustrated by FIG. 2 includes a step of destroying one or more PFAS compounds 20 and a step of sequestering at least a majority of any excessive fluoride ions generated by the step of destroying the one or more PFAS compounds, which as noted above may generate fluoride ions due to the cleaving of several C—F bonds associated with the one or more PFAS compounds. The step of destroying one or more PFAS compounds 20 may include destroying at least a majority of one or more PFAS compounds present in a contaminant-containing liquid by breaking carbon-fluorine bonds present in at least a majority of the one or more PFAS compounds. As noted above, the step of destroying at least a majority of the one or more PFAS compounds may produce (a) one or more hydrocarbon species, one or more organic acids, and/or hydrogen fluoride, and (b) fluoride ions. In this regard, the step of sequestering at least a majority of any excessive fluoride ions generated by the step of destroying the one or more PFAS compounds may include sequestering at least a majority of any excessive fluoride ions generated by the C—F cleaving reaction(s). In accordance with certain embodiments, the step of destroying one or more PFAS compounds 20 may include any of the PFAS compound destroying methods described and disclosed herein.

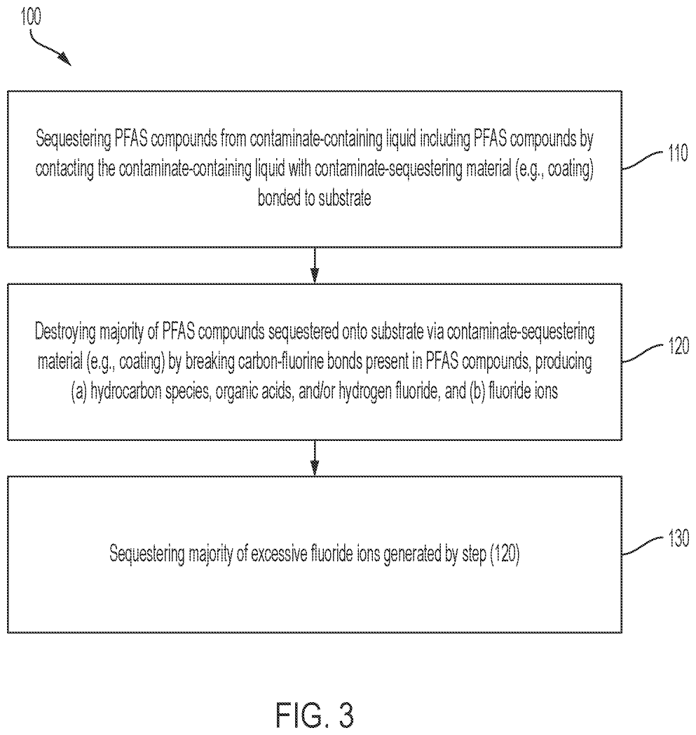

FIG. 3 illustrate another flow diagram for remediation methods 100 in accordance with certain embodiments. The remediation methods illustrated by FIG. 3 includes a step of sequestering one or more PFAS compounds 110 from a contaminant-containing liquid including the one or more PFAS compounds, wherein sequestering the one or more PFAS substances includes contacting the contaminant-containing liquid with a contaminant-sequestering material (e.g., a coating) bonded to a substrate. The remediation method 100 may also include a step of destroying at least a majority of one or more PFAS compounds 120 sequestered onto the substrate via the contaminant-sequestering material (e.g., a coating) by breaking carbon-fluorine bonds present in at least a majority of the one or more PFAS compounds, wherein the step of destroying at least a majority of the one or more PFAS compounds produces (a) one or more hydrocarbon species, one or more organic acids, and/or hydrogen fluoride, and (b) fluoride ions. The remediation method 100 may also include a step of sequestering at least a majority of any excessive fluoride ions 130 generated by the C—F cleaving reaction(s). In accordance with certain embodiments, the step of sequestering one or more PFAS compounds from a contaminant-containing liquid including the one or more PFAS compounds may include contacting the contaminant-containing liquid with a contaminant-sequestering material (e.g., a coating) bonded to a substrate, such as those described and disclosed above and/or additional or alternative contaminant-sequestering materials (e.g., coating). In accordance with certain embodiments, the step of destroying one or more PFAS compounds 20 may include any of the PFAS compound destroying methods described and disclosed herein.

As noted above, certain embodiments include a step of sequestering one or more PFAS compounds from a contaminant-containing liquid including the one or more PFAS compounds by contacting the contaminant-containing liquid with a contaminant-sequestering material (e.g., a coating) bonded to a substrate, such as those described and disclosed above and/or additional or alternative contaminant-sequestering materials (e.g., coating). In this regard, for example, the contaminant-sequestering coating may be formed completely from the non-fluorinated silane compounds according to Formula (I). Alternatively, the contaminant-sequestering coating may be formed at least partially from the non-fluorinated silane compounds according to Formula (I), in which the non-fluorinated silane compounds according to Formula (I) may be co-hydrolyzed with other silane compounds (e.g., fluorinated silane compounds, etc.) including or having different PFAS compound sequestering functionalities (e.g., fluorinated silane compounds, etc.). In accordance with certain embodiments, the network of hydrolyzed silane compounds forming the contaminant-sequestering coating may include from about 0 to about 100% by weight of non-fluorinated silane compounds according to Formula (I), such as at least about any of the following: 0, 3, 5, 10, 15, 20, 25, 30, 35, 40, 45, and 50% by weight, and/or at most about any of the following: 100, 99, 98, 95, 90, 85, 80, 75, 70, 65, 60, 55, and 50% by weight.

In accordance with certain embodiments, the contaminant-sequestering coating includes a network of hydrolyzed silane compounds may optionally including a plurality of fluorine atoms. For example, the network of hydrolyzed silane compounds may include one or more fluorinated silane compounds including a linear C₁-C₂₀₀ perfluorosilane, for example, a linear perfluorosilane or combinations thereof having from at least about any of the following: 1, 3, 5, 8, 10, 12, 15, 20, 25, 30, 40, 50, 60, 70, 80, 90, and 100 carbon atoms and/or at most about 200, 190, 180, 170, 160, 150, 140, 130, 120, 110, 100, and 80 carbon atoms. In accordance with certain embodiments, for example, the network of hydrolyzed silane compounds may be formed from or include a plurality of different perfluorosilane compounds having differing carbon chains (e.g., different lengths of the carbon chain to which fluorine atoms are bonded).

In accordance with certain embodiments, the network of hydrolyzed silane compounds forming the contaminant-sequestering coating may include from about 0 to about 100% by weight of one or more fluorinated silane compounds, such as at least about any of the following: 0, 3, 5, 10, 15, 20, 25, 30, 35, 40, 45, and 50% by weight, and/or at most about any of the following: 100, 99, 98, 95, 90, 85, 80, 75, 70, 65, 60, 55, and 50% by weight. In this regard, for example, the network of hydrolyzed silane compounds forming the contaminant-sequestering coating may include: (i) from about 0 to about 100% by weight of non-fluorinated silane compounds according to Formula (I), such as at least about any of the following: 0, 3, 5, 10, 15, 20, 25, 30, 35, 40, 45, and 50% by weight, and/or at most about any of the following: 100, 99, 98, 95, 90, 85, 80, 75, 70, 65, 60, 55, and 50% by weight; and/or (ii) from about 0 to about 100% by weight of one or more fluorinated silane compounds, such as at least about any of the following: 0, 3, 5, 10, 15, 20, 25, 30, 35, 40, 45, and 50% by weight, and/or at most about any of the following: 100, 99, 98, 95, 90, 85, 80, 75, 70, 65, 60, 55, and 50% by weight.

In accordance with certain example embodiments including fluorinated silane compounds forming all or part of the network of hydrolyzed silane compounds, the one or more of such fluorinated silane compounds may include a cyclic hydrocarbon including from 3 to 200 carbon atoms and having one or more fluorine atoms (e.g., a fluorinated cyclic hydrocarbon). For example, a cyclic hydrocarbon having one or more fluorine atoms may include at least about any of the following: 1, 3, 5, 8, 10, 12, 15, 20, 25, 30, 40, 50, 60, 70, 80, 90, and 100 carbon atoms and/or at most about 200, 190, 180, 170, 160, 150, 140, 130, 120, 110, 100, and 80 carbon atoms. In accordance with certain embodiments, the cyclic hydrocarbon having one or more fluorine atoms may include at least two (2) ring structures, such as at least about any of the following: 2, 3, 4, 5, 6, and 8 ring structures and/or at most about 20, 18, 16, 14, 12, 10, and 8 ring structures. In accordance with certain embodiments, for example, the network of hydrolyzed silane compounds may be formed from or include a plurality of different cyclic hydrocarbons having one or more fluorine atoms (e.g., different number of carbon atoms and/or different number of fluorine atoms).

In accordance with certain example embodiments including fluorinated silane compounds forming all or part of the network of hydrolyzed silane compounds, the one or more of such fluorinated silane compounds may include a non-linear fluorinated hydrocarbon including from 3 to 120 carbon atoms, such as a dendrimer (e.g., molecules having repetitively branched structures that may or may not include cyclic rings within the molecular structure). For example, a fluorinated silane including a non-linear fluorinated hydrocarbon may include at least about any of the following: 3, 4, 5, 6, 8, 10, 12, 15, 18, 20, 25, 30, 40, 50, 60, 70, and 80 carbon atoms and/or at most about 200, 180, 160, 140, 120, 110, 100, 90, 80, and 70 carbon atoms. In accordance with certain embodiments, for example, the network of hydrolyzed silane compounds may be formed from or include a plurality of different non-linear fluorinated hydrocarbons (e.g., different number of carbon atoms and/or different number of fluorine atoms).

In accordance with certain example embodiments including fluorinated silane compounds forming all or part of the network of hydrolyzed silane compounds, the one or more of such fluorinated silane compounds may include from about 4 to about 200 fluorine atoms, such as at least about any of the following: 4, 8, 10, 12, 15, 18, 20, 30, 40, 50, 60, 70, 80, 90, and 100 fluorine atoms and/or at most about any of the following: 200, 180, 160, 140, 120, 100, 90, 80, 70, 60, and 50 fluorine atoms. In accordance with certain embodiments, for example, the network of hydrolyzed silane compounds may be formed from or include a plurality of different fluorinated silanes having a different carbon-based backbone (e.g., different backbone length and/or geometry—branched, linear, cyclic, etc.) and/or a different number of fluorine atoms. (e.g., different number of carbon atoms and/or different number of fluorine atoms).

In accordance with certain example embodiments including fluorinated silane compounds forming all or part of the network of hydrolyzed silane compounds, the one or more of such fluorinated silane compounds may include a substituted hydrocarbon including at least one heteroatom selected from oxygen, nitrogen, sulfur, phosphorus, or combinations thereof.

In accordance with certain example embodiments including fluorinated silane compounds forming all or part of the network of hydrolyzed silane compounds, the one or more of such fluorinated silane compounds may include (i) a polar head region; (ii) a fluorine-containing region; and (iii) an anchor region that forms a bond to a substrate (e.g., inorganic substrate), in which the anchor region includes a silicon atom. In accordance with certain embodiments, the fluorine-containing region may be located between the polar head region and the anchor region. The fluorine-containing region, for example, may include any fluorinated hydrocarbon, such as those disclosed herein. For example, the fluorine-containing region may include a linear carbon backbone, a non-linear carbon backbone, a cyclic carbon backbone having a plurality of fluorine atoms directly or indirectly bonded thereto. The carbon backbone, for example, may be saturated or unsaturated. Additionally, or alternatively, the carbon backbone of the fluorine-containing region may include at least one heteroatom selected from oxygen, nitrogen, sulfur, phosphorus, or combinations thereof. In accordance with certain embodiments, the fluorine-containing region may include from about 4 to about 100 fluorine atoms, such as at least about any of the following: 4, 8, 10, 12, 15, 18, 20, 30, 40, 50, 60, 70, 80, 90, and 100 fluorine atoms and/or at most about any of the following: 200, 180, 160, 140, 120, 100, 90, 80, 70, 60, and 50 fluorine atoms.

In accordance with certain example embodiments including fluorinated silane compounds forming all or part of the network of hydrolyzed silane compounds, the polar head region may include one or more polar functional groups to render this portion of the compound more hydrophilic. The polar head region (e.g., a hydrophilic polar head), for example, may include one or more of one or more of the following example functionalities: hydroxyl groups, carbonyl groups, alcohol groups, and sulfhydryl groups. The polar head region, in accordance with certain embodiments, includes one or multiple units of ethylene glycol (EG) functionality (e.g., a polyethylene glycol (PEG) functionality). The polar head region, for example, may include a plurality of PEG units in a linear structure or a branched structure. In accordance with certain embodiments, the polar head region may include from 2 to 20 PEG units, such as at least about any of the following: 2, 3, 4, 8, 10, and 12, PEG units and/or at most about any of the following: 20, 18, 16, 15, 14, and 12 PEG units. In accordance with certain embodiments, the anchor region that forms a bond to a substrate (e.g., inorganic substrate), in which the anchor region includes a silicon atom, may include one or more one or more hydrolyzable groups (e.g., alkoxy group) bonded to the silicon atom. In accordance with certain embodiments, the anchor region may also include one or more heteroatom selected from oxygen, nitrogen, sulfur, phosphorus, or combinations thereof.

In accordance with certain embodiments, the contaminant-sequestering coating, such as any of the described and disclosed herein, sequesters one or more PFAS compounds initially present in a liquid contaminated with an initial quantity of the PFAS compounds, in which an amount of the one or more PFAS compounds sequestered includes from about 50% to about 100% by weight of the initial quantity of the PFAS compounds. In accordance with certain embodiments, for example, the contaminant-sequestering coating, such as any of the described and disclosed herein, sequesters at least about any of the following: 50, 60, 70, 80, and 85% by weight of an initial quantity of PFAS compounds in a liquid and/or at most about any of the following: 100, 99, 98, 97, 95, 90, 88, and 80% by weight of an initial quantity of PFAS compounds in a liquid. In accordance with certain embodiments, the PFAS compounds include PFOS, PFOA, or both.

In accordance with certain embodiments, the contaminant-sequestering coating, such as any of the described and disclosed herein, may be bonded to a substrate of interest. For example, the substrate (e.g., inorganic substrate) may not be particularly limited and may include a filtration medium, nonwoven matt, nanofiltration membrane, microfiltration membrane, reverse osmosis membrane, an ion exchange resin, a structured packing material, or a random packing material (e.g., raschig rings). For example, the contaminant-sequestering coating may be disposed onto a variety of inorganic substrate, including a variety of filtration media, such as an aluminum oxide hydroxide (γ-AlOOH) mineral. In accordance with certain embodiments, the substrate includes a filtration medium that may include an aluminum oxide hydroxide (γ-AlOOH) mineral attached to micro-glass strands (e.g., an Ahlstrom DISRUPTOR® 4603 filter). In accordance with certain embodiments, the filtration medium may include an ultra-filter medium, a nano-filter medium, or a reverse osmosis membrane. The substrate may also include, for example, an ion-exchange resin. In accordance with certain embodiments, the substrate includes an aluminum oxide hydroxide (γ-AlOOH) mineral that may sequester or bind one or more biological species, such as Escherichia coli (E. coli) and/or virus bacteriophage MS2. In accordance with such embodiments, an initial quantity of one or more biological species may be reduced (e.g., sequester, removed, etc.) from at least about any of the following: 50, 60, 70, 80, and 85% by weight of an initial quantity of the biological species in a liquid and/or at most about any of the following: 100, 99, 98, 97, 95, 90, 88, and 80% by weight of an initial quantity of biological species in a liquid. In accordance with certain embodiments, a combination of one or more PFAS compounds, one or more heavy metals, and one or more biological species may simultaneously be reduced (e.g., sequester, removed, etc.) from at least about any of the following: 50, 60, 70, 80, and 85% by weight of an initial quantity thereof in a liquid and/or at most about any of the following: 100, 99, 98, 97, 95, 90, 88, and 80% by weight of an initial quantity thereof in a liquid.

In another aspect, certain embodiments provide a liquid composition including a flowable carrier medium and a plurality of hydrolyzable silane compounds, in which the plurality of hydrolyzable silane compounds may include: (i) from about 0 to about 100% by weight on a dry basis of non-fluorinated silane compounds according to Formula (I), such as at least about any of the following: 0, 3, 5, 10, 15, 20, 25, 30, 35, 40, 45, and 50% by weight on a dry basis, and/or at most about any of the following: 100, 99, 98, 95, 90, 85, 80, 75, 70, 65, 60, 55, and 50% by weight on a dry basis; and/or (ii) from about 0 to about 100% by weight on a dry basis of one or more fluorinated silane compounds, such as at least about any of the following: 0, 3, 5, 10, 15, 20, 25, 30, 35, 40, 45, and 50% by weight on a dry basis, and/or at most about any of the following: 100, 99, 98, 95, 90, 85, 80, 75, 70, 65, 60, 55, and 50% by weight on a dry basis. In accordance with certain embodiments, the flowable carrier medium may include an organic solvent, an alcohol, or an aqueous-based solvent (e.g., water). The liquid composition, for example, may include a solution, suspension, or colloid including a plurality of hydrolyzable silane compounds, such as those described and disclosed herein.

In this regard, certain embodiments also provide a method of functionalizing a substrate surface with contaminant-sequestering functionalities. In accordance with certain embodiments, the method of functionalizing a substrate surface with contaminant-sequestering functionalities includes covering a substrate (e.g., an inorganic substrate) with a liquid composition including a plurality of hydrolyzable silane compounds, such as those described and disclosed herein. In accordance with certain embodiments, the step of covering a substrate (e.g., an inorganic substrate) with a liquid composition including a plurality of hydrolyzable silane compounds may include submerging the substrate within the liquid composition, which may be housed within a vessel, or pumping the liquid composition over the surface of the substrate and/or through the thickness of the substrate (e.g., pumping the liquid composition through a filter media or through a bed of ion-exchange resin). Additionally or alternatively, the liquid composition may be sprayed or brushed onto the substrate as discussed above. In accordance with certain embodiments, the step of covering the substrate with the liquid composition may include contacting the substrate with the liquid composition for at least about 0.5 minutes to about 120 minutes, such as at least about any of the following: 0.5, 1, 5, 10, 15, 25, 30, 40, 50, 60, 70, 80, and 90 minutes and/or at most about 120, 110, 100, 90, 80, and 70 minutes.

In accordance with certain embodiments, the method of functionalizing a substrate surface with contaminant-sequestering functionalities may further include cleaning the substrate (e.g., inorganic substrate) prior to covering the substrate (e.g., inorganic substrate) with the liquid composition. For example, the step of washing the base surface with alcohol, acetone, toluene and the like, the step of cleaning the substrate (e.g., inorganic substrate) may include oxygen plasma treating the substrate prior to contacting the substrate with the liquid composition having a plurality of hydrolyzable silane compounds, in which cleaning (e.g., pre-treating the surface of the substrate) the substrate may facilitate silanization of the substrate.

In another aspect, certain embodiments provide a method of removing contaminants from a contaminant-containing liquid, in which the methods include contacting the contaminant-containing liquid with a contaminant-sequestering coating, such as any of those described and disclosed herein. In accordance with certain embodiments, the contaminant-containing liquid includes water. In accordance with certain embodiments, the contaminant-containing liquid includes water including one or more PFAS compounds.

In accordance with certain embodiments, the contaminant-containing liquid may be pumped across and/or through the substrate either as a single pass or multiple passes (e.g., recirculating the contaminant-containing liquid through a filter or ion-exchange bed including the contaminant-sequestering coating) until a desired reduction in PFAS is realized. In accordance with certain embodiments, the contaminant-sequestering coating sequesters from about 50% to about 100% by weight of an initial quantity of the PFAS compounds. In accordance with certain embodiments, for example, the contaminant-sequestering coating sequesters at least about any of the following: 50, 60, 70, 80, and 85% by weight of an initial quantity of PFAS compounds in a liquid and/or at most about any of the following: 100, 99, 98, 97, 95, 90, 88, and 80% by weight of an initial quantity of PFAS compounds in a liquid. In accordance with certain embodiments, the PFAS compounds include PFOS, PFOA, or both.

In accordance with certain embodiments, the method of removing contaminants from a contaminant-containing liquid includes reducing PFOS and/or PFOA to less than about 80 parts-per-trillion (ppt), such as less than about 75 ppt, less than 70 ppt, less than 60 ppt, or less than 50 ppt.

### EXAMPLES

The present disclosure is further illustrated by the following examples, which in no way should be construed as being limiting. That is, the specific features described in the following examples are merely illustrative and not limiting.

### Example (I) PFAS Compound Sequestering with a Hydrolyzed Network of Non-Fluorinated Silane Compounds

A non-fluorinated silane compound (i.e., H16-4PEG silane) in accordance with certain embodiments was successfully prepared according to Example Reaction Scheme (I), which is illustrated below.

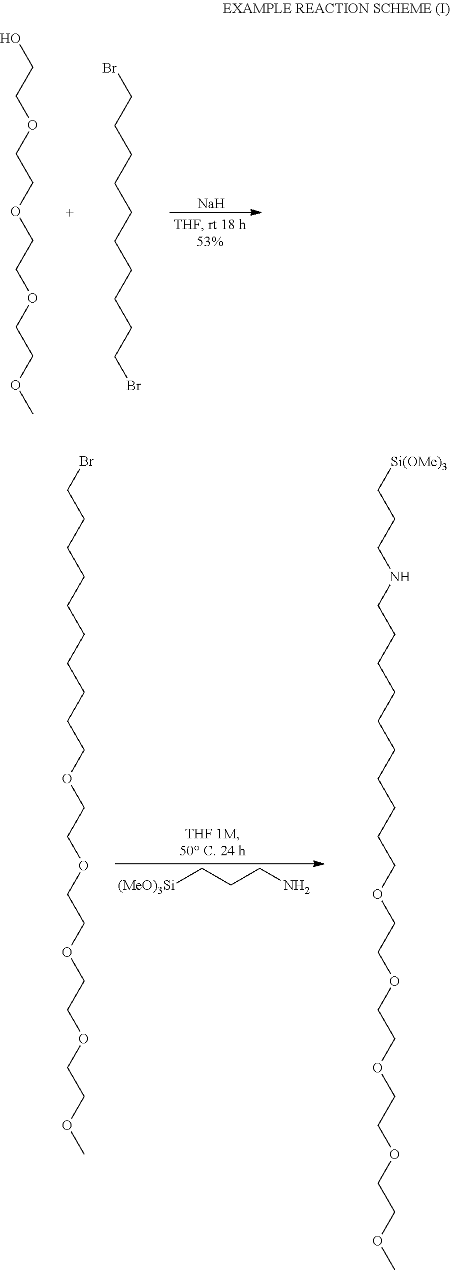

A commercial γ-AlOOH filtration media AHLSTROM DISRUPTOR® 4603 available from Ahlstrom Filtration LLC (Mt Holly Springs, Pa.) was functionalized with the non-fluorinated silane compounds formed via Reaction Scheme (I). After being functionalized (e.g., formation of a network of hydrolyzed non-fluorinated compound H16-4PEG silane thereon), dynamic filtration experiments using 18 PFAS challenge water (EPA 537.1) was performed, as well as break-through experiments using PFOA and PFOS challenge water. The functionalized filter media exhibited greater than 99% removal or sequestering of the PFAS compounds.

For the substrate functionalization, substrates were placed in a 1% (w/v) solution of silane in 95% ethanol with 0.1% (v/v) acetic acid and placed on a shaker table for 24 h (150 rpm). The filters were collected by vacuum filtration, washed with ethanol, and dried under vacuum

### Example (II) PFAS Destruction Using FLP Chemistry

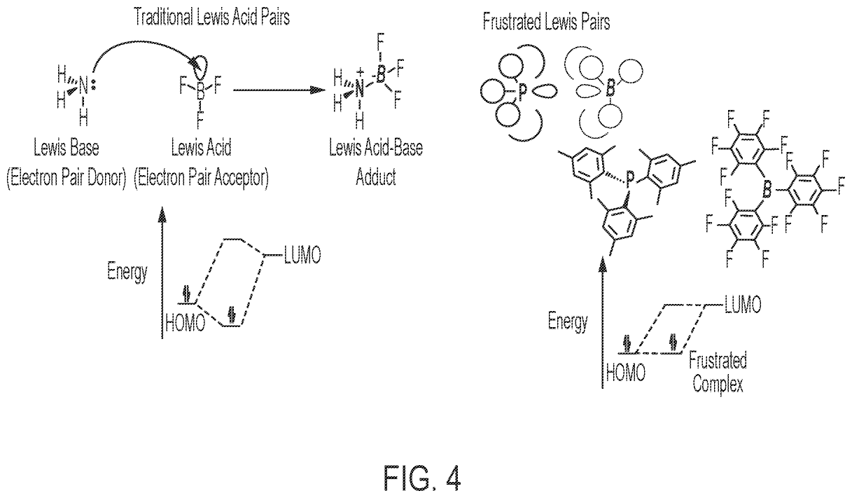

The use of FLP chemistry was tested based on the anticipated (and confirmed) lower energy LUMO of FLPs leading to increased reactivity as generally illustrated by FIG. 4. In this regard, a first test utilizing FLP chemistry was carried out according to Example Reaction Scheme (II). In particular, a solution of PFAS (10 mg) in triethyl silane (0.45 mL) was treated with triphenylcarbenium tetrakis(pentafluorophenyl)borate (15 mg, 50 mol %). The reaction was stirred at 100° C. for 24 hours and residual PFAS concentration was analyzed by 19F NMR. This PFAS destruction technique provided a 99.96% destruction of the originally present PFAS compounds based on LCMS/MS analysis. The efficiency of this PFAS destruction technique is believed to be attributed, at least in part, the highly electrophilic silicon species. For instance, the PFAS destruction may be considered as silylium-catalyzed hydrodefluorination in which the generation of the silylium ion is achieved using trityltetrakis[3,5-bis(trifluoromethyl)phenyl]borate.

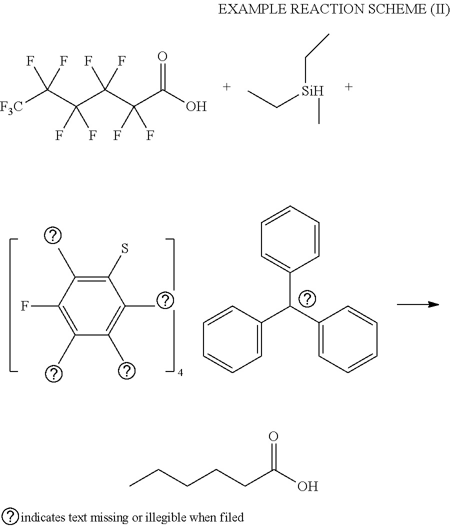

### Example (III) PFAS Destruction Using Fenton Chemistry Leveraging Magnetite Nanoparticles as a Catalyst

Next, a method of destroying one or more PFAS compounds based on magnetite-catalyzed UV-Fenton chemistry was performed, in which the magnetite-catalyzed UV-Fenton chemistry provided a destruction of greater that 95% of PFAS compounds. Beneficially, the magnetite-catalyzed Fenton chemistry for the destruction of one or more PFAS compounds may be performed at a neutral pH (e.g., pH of 7), that of drinking water, whereas previous studies have only achieved efficient removal at either very low pH for aqueous Fe ions or high pH, such as a pH greater than 9. Moreover, the magnetite-catalyzed UV-Fenton chemistry for the destruction of one or more PFAS compounds have been demonstrated to provide high levels of PFAS compound destruction with as little as about 30 minutes of UV exposure.

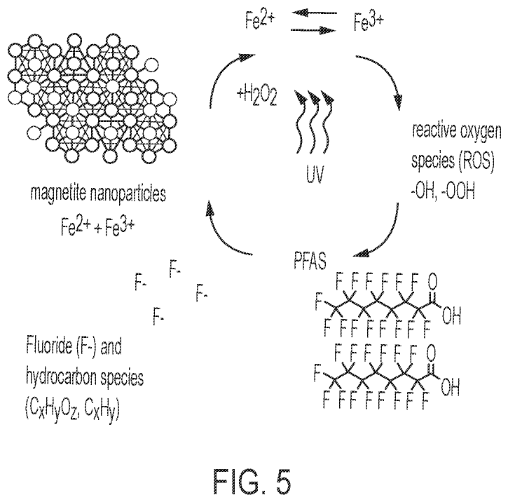

FIG. 5 illustrates a general method of destroying one or more PFAS compounds based on magnetite-catalyzed Fenton chemistry in accordance with certain embodiments. Specifically, FIG. 5 illustrates a general method including magnetite nanoparticles in the presence of hydrogen peroxide (H₂O₂) and exposure to UV radiation catalyzing the formation of radical reactive oxygen species, which go on to cleave C—F bonds and destroy PFAS. In the method, the UV exposure occurred for 30 minutes, and 3 solution pH levels were tested (5, 7, and 9) to determine different destruction levels of PFAS.

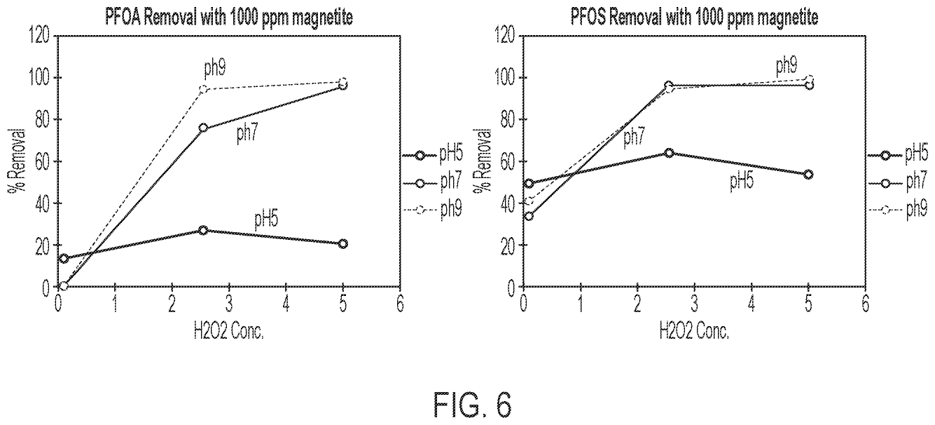

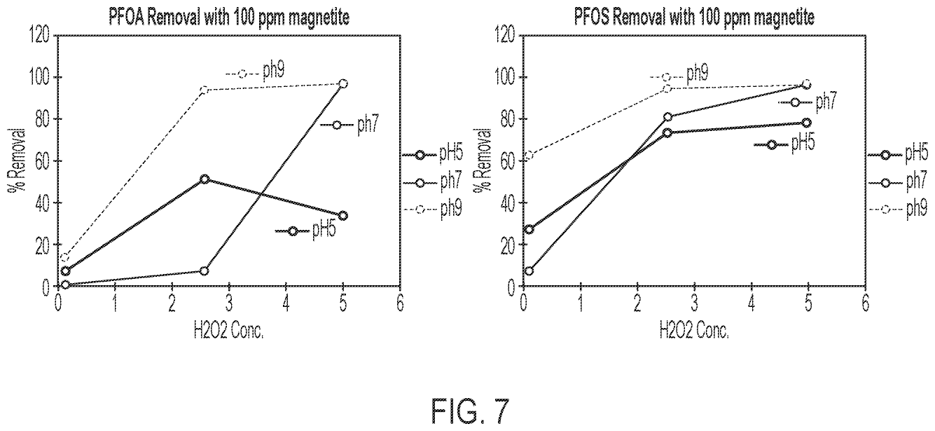

FIG. 6, for example, illustrates >95% PFOA removal at neutral pH (pH 7), at 5M concentrations of peroxide, while PFOS was more easily removed than PFOA and achieved >95% removal even at neutral pH with lower peroxide concentration. FIG. 7, for example, illustrates that at a relatively high peroxide concentration, such methods can achieve >95% removal of PFOA and PFOS even with only 100 ppm of magnetite nanoparticles, which illustrates that magnetite is particularly efficient at catalyzing this reaction.

These and other modifications and variations to the invention may be practiced by those of ordinary skill in the art without departing from the spirit or scope of the invention, which is more particularly set forth in the appended claims. In addition, it will be understood that aspects of the various embodiments may be interchanged, in whole or in part. Furthermore, those of ordinary skill in the art will appreciate that the foregoing description is by way of example only, and it does not limit the invention as further described in such appended claims. Therefore, the spirit and scope of the appended claims is not limited to the exemplary description of the versions contained herein.

What is claimed is:

1. A contaminant-sequestering coating, comprising a network of hydrolyzed silane compounds including (a) a hydrophilic polar head region, (b) a hydrophobic linker, and (c) an anchor region including a silicon atom, wherein the network of hydrolyzed silane compounds is devoid or substantially devoid of fluorine atoms.

2. The contaminant-sequestering coating of claim 1, wherein the network of hydrolyzed silane compounds is formed from one or more hydrolyzable silane compounds according to Formula (I): 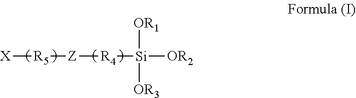
and wherein
OR₁, OR₂, and OR₃ are each hydrolyzable groups,
R₄ is a saturated C₁-C₂₀ radical or an unsaturated C₁-C₂₀ radical,
R₅ is a saturated C₁-C₂₀ radical or an unsaturated C₁-C₂₀ radical,
Z is a heteroatom selected from oxygen, nitrogen, sulfur, and phosphorus, and
X is a polar group selected from —OH, —SH, or one or more ethylene glycol (EG) units.

3. The contaminant-sequestering coating of claim 2, wherein (i) OR₁, OR₂, and OR₃ each comprise a respective alkyl group having from 1 to 5 carbon atoms, (ii) R₄ comprises a saturated C₁-C₅ radical or an unsaturated C₁-C₅ radical, (iii) Z is a nitrogen atom, (iv) R₅ comprises a saturated C₅-C₁₂ radical or an unsaturated C₅-C₁₂ radical; and (v) X comprises from 2 EG units to about 10 EG units.

4. The contaminant-sequestering coating of claim 1, wherein the network of hydrolyzed silane compounds is devoid or substantially devoid of thiol groups.

5. The contaminant-sequestering coating of claim 1, wherein the contaminant-sequestering coating is disposed onto a surface of a substrate.

6. A method of removing contaminants from a contaminant-containing liquid, the method comprising contacting the contaminant-containing liquid with a contaminant-sequestering coating, wherein
the contaminant-sequestering coating comprises a network of hydrolyzed silane compounds including (a) a hydrophilic polar head region, (b) hydrophobic linker, and (c) an anchor region including a silicon atom, and
the network of hydrolyzed silane compounds is devoid or substantially devoid of fluorine atoms.

7. A method of destroying one or more perfluoroalkyl and/or polyfluoroalkyl (PFAS) compounds present in a contaminant-containing liquid, the method comprising breaking carbon-fluorine bonds present in at least a majority of the one or more PFAS compounds present in the contaminant-containing liquid, wherein the destroying the one or more PFAS compounds produces (a) one or more hydrocarbon species or one or more organic acids, hydrogen fluoride, and (b) excessive fluoride ions.

8. The method of claim 7, wherein the destroying the one more PFAS compounds further comprises (a) forming a reactant mixture including the one or more PFAS compounds from the contaminant-containing liquid, a Frustrated Lewis Pair (FLP) including a Lewis acid and a Lewis base, and a reducing agent, and (b) performing a fluoride-cleaving reaction breaking carbon-fluorine bonds present in the at least a majority of the one or more PFAS compounds by maintaining the reactant mixture at an elevated temperature for a reaction time sufficient to achieve a desired degree of fluoride abstraction on the one or more PFAS compounds.

9. The method of claim 8, wherein the elevated temperature comprises from about 30° C. to about 150° C. and the reaction time comprises from about 6 hours to about 36 hours.

10. The method of claim 8, wherein the Lewis acid comprises a silylium ion including one or more alkyl radicals bonded to a silicon atom of the silylium ion.

11. The method of claim 8, wherein the Lewis base comprises a boron-containing Lewis base.

12. The method of claim 11, wherein the boron-containing Lewis base comprises a tetraarylborane or weakly coordinating anion species

13. The method of claim 8, wherein the reducing agent comprises a silane reducing agent.

14. The method of claim 8, wherein
the one or more PFAS compounds are sequestered via a contaminant-sequestering material comprising a coating bonded to a substrate, and
the forming the reactant mixture comprises mixing the substrate having the one or more PFAS compounds sequestered thereon, the reducing agent, and the FLP, and performing the fluoride-cleaving reaction in the presence of the substrate.

15. The method of claim 7, wherein the destroying the one more PFAS compounds further comprises (a) forming a reaction mixture including the one or more PFAS compounds, a plurality of magnetite nanoparticles, hydrogen peroxide, and optionally one or more sulfates, and (b) performing a fluoride-cleaving reaction breaking carbon-fluorine bonds present in at least a majority of the one or more PFAS compounds by exposing the reaction mixture to ultraviolet (UV) radiation.

16. The method of claim 15, wherein the reaction mixture is exposed to UV radiation from about 0.25 hours to about 24 hours, and the reaction mixture is maintained at a pH from about 5 to about 9 during the fluoride-cleaving reaction, and wherein the plurality of magnetite nanoparticles have an average diameter from about 1 nm to about 100 nm.

17. The method of claim 7, wherein
the destroying the one more PFAS compounds further comprises an electrochemical oxidative process that directly or indirectly oxidizes the one or more PFAS compounds via catalysis-induced reactive free radicals at one or more electrodes, and
the electrochemical oxidative process includes a niobium-doped titanium oxide (NB-doped TiO₂) catalyst.

18. The method of claim 17, wherein the NB-doped TiO₂ includes from about 5 atomic percent of niobium to about 20 atomic percent of niobium.

19. A perfluoroalkyl and/or polyfluoroalkyl (PFAS) remediation method, the method comprising at least two of the following:
(i) sequestering one or more PFAS compounds from a contaminant-containing liquid including the one or more PFAS compounds, wherein sequestering the one or more PFAS compounds comprises contacting the contaminant-containing liquid with a contaminant-sequestering material;
(ii) destroying at least a majority of the one or more PFAS compounds by breaking carbon-fluorine bonds present in the at least a majority of the one or more PFAS compounds, wherein the step of destroying the at least a majority of the one or more PFAS compounds produces (a) one or more hydrocarbon species, one or more organic acids, and/or hydrogen fluoride, and (b) excessive fluoride ions; and
(iii) sequestering the excessive fluoride ions in the liquid.

20. The remediation method of claim 19, wherein the step of destroying the at least a majority of the one or more PFAS compounds by breaking carbon-fluorine bonds present in the at least a majority of the one or more PFAS compounds includes any combination of the following:
(i) (a) forming a reactant mixture including the one or more PFAS compounds from the contaminant-containing liquid, a Frustrated Lewis Pair (FLP) including a Lewis acid and a Lewis base, and a reducing agent, and (b) performing a fluoride-cleaving reaction breaking carbon-fluorine bonds present in the at least a majority of the one or more PFAS compounds by maintaining the reactant mixture at an elevated temperature for a reaction time sufficient to achieve a desired degree of fluoride abstraction on the one or more PFAS compounds;
(ii) (a) forming a reaction mixture including the one or more PFAS compounds, a plurality compounds magnetite nanoparticles, hydrogen peroxide, and optionally one or more sulfates, and (b) performing a fluoride-cleaving reaction breaking carbon-fluorine bonds present in the at least a majority of the one or more PFAS compounds by exposing the reaction mixture to ultraviolet (UV) radiation; and
(iii) performing an electrochemical oxidative process that directly or indirectly oxidizes the one or more PFAS compounds via catalysis-induced reactive free radicals at one or more electrodes, wherein the electrochemical oxidative process includes a niobium-doped titanium oxide (NB-doped TiO₂) catalyst.
